(19) United States
(12) Patent Application Publication
(10) Pub. No.: US 2008/0019238 A1
(43) Pub. Date: Jan. 24, 2008

(54) Record Carrier And Methods For Writting A Record Carrier

(75) Inventors: Erwin Rinaldo Meinders, Eindhoven (NL); Elise Rodenburg, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/570,783

(22) PCT Filed: Jun. 21, 2005
(86) PCT No.: PCT/IB05/52024

§ 371 Date: Dec. 18, 2006

(30) Foreign Application Priority Data
Jun. 28, 2004 (EP) 04102995.0

(51) Int. Cl. G11B 7/00

(52) U.S. Cl. 369/44.39; 369/284

(57) ABSTRACT

The present invention relates to a record carrier (10) for creating a multi-level ROM optical medium, wherein the record carrier 10 comprises a first recording layer (12) and at least a second recording layer (14). In accordance with the invention between said first recording layer (12) and said second recording layer (14) there is provided a physical barrier (16) leading to discrete pit depths. Furthermore, the invention relates to two methods for writing a record carrier to create a multi-level ROM optical medium.

### FIELD OF THE INVENTION

The present invention relates to a record carrier for creating a multi-level ROM optical medium, wherein said record carrier comprises a first recording layer and at least a second recording layer. Furthermore, the invention relates to two methods for writing a record carrier to create a multi-level ROM optical medium, wherein the record carrier comprises a first recording layer and at least a second recording layer.

### BACKGROUND OF THE INVENTION

An important trend in optical data storage is the strive for higher data capacities. There has been an evolutionary increase in data capacity from the single layer CD (650 MB) to the DVD (4.7 GB) and the recently introduced Blu-ray Disc (BD, 25 GB). A capacity doubling was obtained by introducing dual-layer data storage media and more data storage layers in a single recording medium are anticipated. Other methods to increase data capacity are also foreseen, like magneto-optical recording and readout and near field recording. Also improved signal processing, like the Viterbi detection, is a way to further increase the data capacity of a data storage medium. The two-dimensional data storage in the disc plane is a novel way to increase capacity. The anticipated data capacity of the two-dimensional data storage is estimated to be at least a factor 2. The known two-dimensional data storage is based on two basic reflection levels: the pit (written) and the land (unwritten) areas. The detection of a two-dimensional data pattern is based on additional information obtained from the adjacent tracks when scanning the central track. The two-dimensional storage concept is mainly meant for ROM storage media, but write-once and re-writable storage media and corresponding recording methods are also known and disclosed.

FIG. 6a shows an example of a two-dimensional data pattern 30′ in accordance with the prior art. Besides the matrix level 24′ (back-ground material) there do exist only pits 26′ having a different reflection level than the matrix level. The difference in reflection level is, for example, due to constructive and destructive interference of the readout laser spot (well-known phase modulation) but the pits may also have a different absolute reflection level than the surrounding matrix material has. A ROM medium as depicted in FIG. 6a can be replicated via injection moulding or other replication technique from a so-called stamper. A stamper is typically a Nickel substrate with protruding bumps representing the ROM data. The stamper is made via mastering with a so-called conventional Laser Beam Recorder (LBR) system. An LBR is used to illuminate a photosensitive polymer layer of a specific thickness that is spincoated on top of a glass substrate. The glass substrate with photo-resist layer, and optionally other layers to improve the absorption of the laser light, is referred to as master substrate. The master substrate is rotated while the focused laser spot is slowly pulled over the master substrate. In this way a spiral or concentric rings of illuminated spots is obtained. If the laser pulse pattern is synchronized with the rotation of the master substrate during recording of data such that the data written in the central track is synchronized with the data in the adjacent tracks, a synchronized two-dimensional data pattern is obtained. The exposed/illuminated areas are chemically removed via etching, such that physical pits 26′ remain in the resist layer. The obtained relief structure is provided with a sputter-deposited metallic layer, preferably Nickel. This Ni layer is grown to a thick and manageable substrate via electro-chemical plating. The Ni substrate is separated from the master substrate to end up with the stamper. The stamper is subsequently used to replicate optical storage media. A possibility to make a multi-level ROM medium is by power modulations of the write pulses. High-power write pulses are intended to write broad and deep pits of low reflection and pulses with a lower write power are meant for shallow pits of moderate reflection. A big drawback of this power modulation concept is the sensitivity for system noise. To accurately write data in a photoresist layer, the entire depth is typically utilized. The layer thickness acts as a natural boundary that shapes the pits and leads to reproducible pits. Writing at different power levels in deep resist has proven to be very difficult and very sensitive for write power variations etc.

It is the object of the present invention to further develop the record carriers and the methods of the type mentioned above such that a ROM medium with basically more than two reflection levels may be accurately made to further increase the data capacity of the record carriers.

### SUMMARY OF THE INVENTION

This object is solved by the features of the independent claims. Further developments and preferred embodiments of the invention are outlined in the dependent claims.

In accordance with a first aspect of the present invention a record carrier for creating a multi-level ROM, comprising a first recording layer and at least a second recording layer, is characterized in that between said first recording layer and said second recording layer there is provided a physical barrier leading to discrete pit depths. Such a record carrier can be mastered with conventional Laser Beam Recorders (LBR) and is intended for single- and two-dimensional data storage concepts. The recording layers are preferably made of photoresist material. The invention provides a high data capacity ROM disc, which is for example especially beneficial for a small form factor optical disc (portable blue). One for example could imagine a road map starting from 1 GB on a 3 cm disc, going to 2 GB by adding a second layer and reaching 4.5 GB by combining the dual-layer storage with the two-dimensional storage. It is to be noted, that the invention is not limited to using only two recording layers for creating two different reflection levels, but embraces also record carriers having more than two recording layers for providing a corresponding number of different reflection levels. Furthermore, the arrangement of the data is not limited to a spiral form or a concentric arrangement of the data tracks. Other types of data patterns are also possible, for example rectangular or square grid, or a triangular grid.

In accordance with a first general embodiment of the record carrier in accordance with the invention said physical barrier comprises an interface layer that breaks down by a predetermined breakdown mechanism, particularly by a photochemical reaction or a thermal effect. It should be clear that in cases where more than two recording layers are provided a suitable interface layer is preferably arranged between all adjacent recording layers. In cases where the break down mechanism is a thermal effect, the optical properties of the record carrier for example change due melting, thermal degradation or other thermal alteration mechanism.

A further development of the first embodiment is that said interface layer is bleachable by a certain amount of photons, wherein the bleached material is solvable in a developer used in said photochemical reaction.

In accordance with another further development of the first embodiment said interface layer is an inhibition layer, which becomes sensitive above a predetermined laser power of a laser used for mastering. For example, a first photoresist layer can be spincoated, baked and treated with a pre-development. Then, a second photoresist layer is spincoated and baked. The inhibition layer was initially part of the first photoresist layer but obtained different chemical (and optical) properties due to the treatment with the development liquid during the pre-development.

In connection with the first embodiment of the record carrier in accordance with the invention said interface layer is preferably made from a material selected from the following group: PMMA, silicon nitride, aluminum nitride.

In accordance with a second general embodiment of the record carrier in accordance with the invention said physical barrier is formed in that said first recording layer and said second recording layer are made from intrinsic different materials. In this case the different recording layers are for example spincoated or deposited on top of each other.

In accordance with a further development of the second general embodiment of the record carrier in accordance with the invention said first recording layer and said second recording layer comprise different photosensitive compounds.

Furthermore, it is possible that said first recording layer and said second recording layer comprise different compositions.

Additionally or alternatively it is possible in connection with the second general embodiment that said first recording layer and said second recording layer comprise different sensitivities with respect to laser (UV) illumination. It is for example possible to spincoat a photoresist having a lower sensitivity onto a substrate to form a second recording layer, and to subsequently spincoat a photoresist having a higher sensitivity onto the second recording layer to form a first recording layer, wherein in this case, the second recording layer is only reached at high laser power levels.

Another possibility is that said first recording layer and said second recording layer comprise different sensitivities with respect to a photochemical development.

In connection with the second general embodiment of the record carrier in accordance with the invention it is also possible, that said first recording layer and said second recording layer comprise different sensitivities with respect to different etching agents. For example, the first recording layer may be formed by a photoresist and the second recording layer may be formed by a glass substrate.

Although the invention is not limited thereto, it is preferred that the record carrier in accordance with the invention is adapted for two-dimensional data recording.

In this connection it is possible, that the record carrier comprises a two-dimensional data pattern with at least two reflection levels different from a matrix level. Although by this solution a very high data density is achieved, it is pointed out again, that the invention is also applicable in connection with conventional optical recording media, such as DVD- and BD-kind of media.

In accordance with a second aspect of the present invention the above object is solved by a method of the type mentioned at the beginning, which comprises the following steps:

providing a record carrier having a physical barrier leading to discrete pit depths between said first recording layer and said second recording layer; and

writing, with a modulated laser beam, a plurality of pits on said record carrier, wherein:

for writing pits having a first depth, the power of said modulated laser beam is selected such that said first recording layer is penetrated without breaking down said physical barrier; and

for writing pits having a second depth larger than said first depth, the power of said modulated laser beam is selected such that said first recording layer is penetrated, said physical barrier is broken down, and said second recording layer is penetrated.

Also by this solution a ROM pattern may be generated which comprises discrete pit depths and thus improved properties. It is clear for the person skilled in the art that also in this case more than two recording layers may be provided, wherein a corresponding number of physical suitable barriers and laser power levels has to be selected.

With preferred embodiments of the method in accordance with the second aspect said physical barrier comprises an interface layer. In this case the method may be used advantageously in connection with the first general embodiment of the record carrier in accordance with the invention.

In accordance with a third aspect of the invention the above object is solved by a method for writing a record carrier to create a multi-level ROM of the type mentioned at the beginning, which comprises the following steps:

providing a record carrier having a physical barrier leading to discrete pit depths between said first recording layer and said second recording layer; and

mastering said record carrier with a modulated laser beam such that for pits to be created with a first depth said modulated laser beam has a relative low intensity and for pits to be created with a second depth larger than said first depth said modulated laser beam has a relative high intensity, wherein said relative high intensity is selected such that said first recording layer is completely penetrated;

developing said first recording layer to remove the mastered regions, wherein said second recording layer is exposed at positions where pits having the second depth are to be formed;

performing a first etching step to remove at least a part of said second recording layer at said exposed positions ; and

performing a second etching step to remove at least part of said first recording layer at positions where pits having said first depth are to be formed.

Also by this solution it is possible, to create a pit pattern having accurate discrete pit depths. Without being limited thereto, the second method in accordance with the invention may be used advantageously in connection with the second general embodiment of the record carrier in accordance with the invention.

To carry out this method the first recording layer may for example be a photoresist, which is spincoated on a glass substrate forming the second recording layer. The etching steps preferably comprise reactive iron etching (RIE), wherein in the first etching step for example CF₄ may be used, while in the second etching step for example O₂ may be used.

These and other aspects of the invention will be apparent from and elucidated with reference to the embodiments described hereinafter.

### BRIEF DESCRIPTION OF THE DRAWINGS

FIG. 1 is a flow chart illustrating a first embodiment of a method in accordance with the invention;

FIG. 2 schematically illustrates the first general embodiment of the record carrier in accordance with the invention in a sectional view, and it also illustrates the application of two different laser power levels;

FIG. 3 illustrates the record carrier of FIG. 2 after development in a sectional view;

FIG. 4 is a flow chart illustrating a second embodiment of a method in accordance with the invention;

FIG. 5 illustrates a record carrier in accordance with the second general embodiment in a sectional view in different states, when the method of FIG. 4 is carried out;

FIG. 6a shows a two-dimensional data pattern in accordance with the prior art; and

FIG. 6b shows a two-dimensional data pattern with two reflection levels different from a matrix level provided on a record carrier in accordance with the invention.

### DESCRIPTION OF PREFERRED EMBODIMENTS

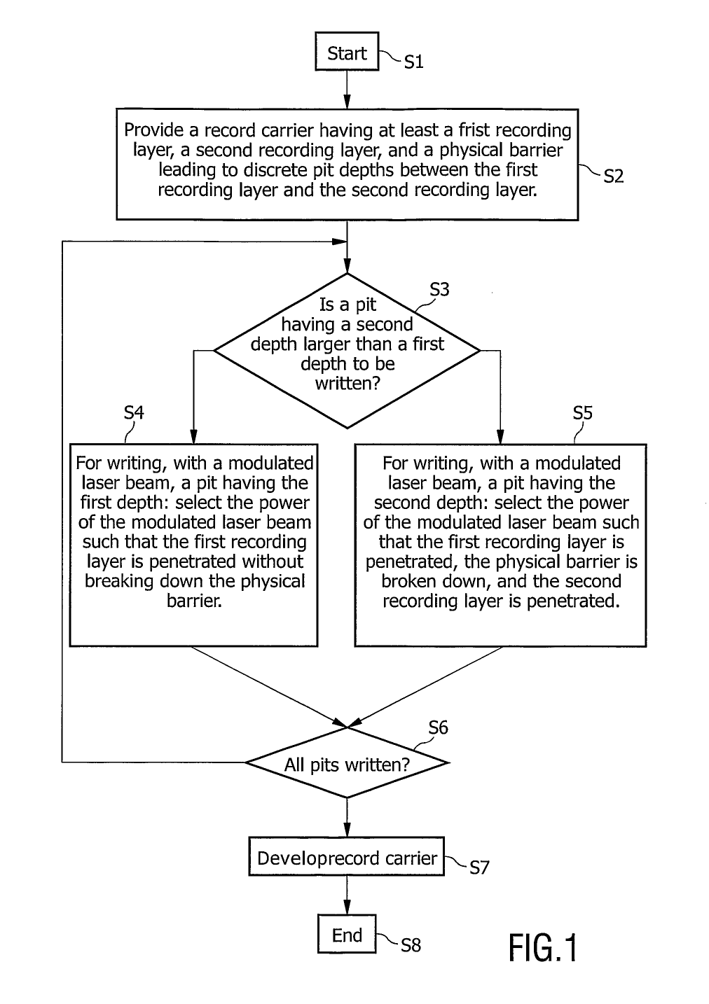

The method shown in FIG. 1 starts in step S1. In step S2 a record carrier having at least a first recording layer, a second recording layer, and a physical barrier leading to discrete pit depths between said first recording layer and said second recording layer is provided. In step S3 it is determined whether a pit having a second depth larger than a first depth is to be written. If this is not the case, in step S4 the pit having the first depth is written, wherein the power of the modulated laser beam used for writing is selected such that the first recording layer is penetrated without breaking down the physical barrier. If it is determined in step S3 that a pit having the second depth larger than the first depth is to be written, the method proceeds to step S5. In step S5 the pit having the second depth is written, wherein the power of the modulated laser beam used for writing is selected such that the first recording layer is penetrated, the physical barrier is broken down, and the second recording layer is penetrated. After step S4 or step S5 it is determined in step S6 whether all pits are written. If this is not the case the method again proceeds to step S3. If all pits are written, the record carrier is developed in step S7 and the method ends in step S8.

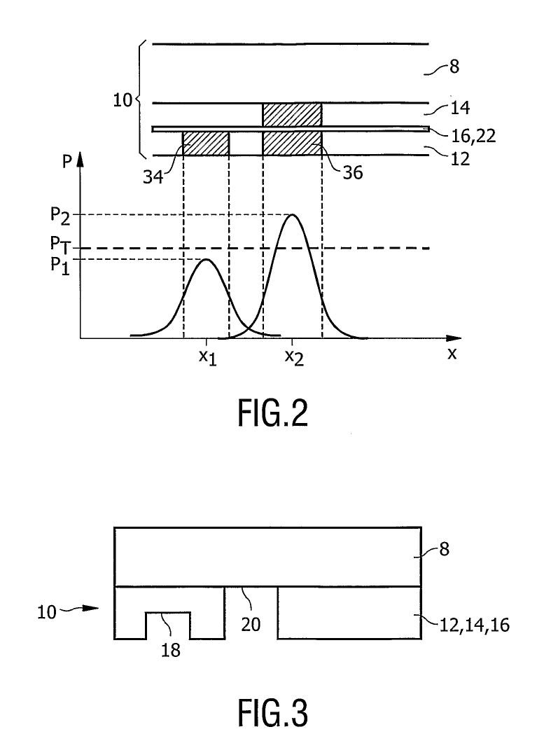

FIG. 2 shows a record carrier in accordance with the first general embodiment discussed above. The record carrier 10 comprises a substrate 8 on which a second photoresist recording layer 14 is spincoated. An interface layer 22 forming the physical barrier 16 is provided between the second recording layer 14 and a first recording layer 12, which is also formed by a photoresist. To carry out the method shown in FIG. 1 with the record carrier 10, different laser power levels P are used. To prepare a pit having the first depth at the position X₁, the laser power is adjusted to a power level P₁. The power level P₁ is selected such that the first recording layer 12 is penetrated without breaking down the interface layer 22. To prepare a pit having the second depth larger than the first depth at the position X₂, the laser power is adjusted to a value P₂ which is selected such that the first recording layer 12 is penetrated, the interface layer 22 is broken down since the power level P₂ is higher than a threshold value P_{T}, and the second recording layer 14 is penetrated. The adoption of a photon leads to the formation, via a chemical chain process, of an acid.

FIG. 3 shows the record carrier 10 of FIG. 2 after the development. For developing the record carrier 10 is flushed with development liquid (KOH, NaOH, or other alkaline liquid) which leads to a dissolution of the acid molecules leaving physical holes inside the recording layer. The resulting record carrier 10 comprises discrete pits depths 18, 20.

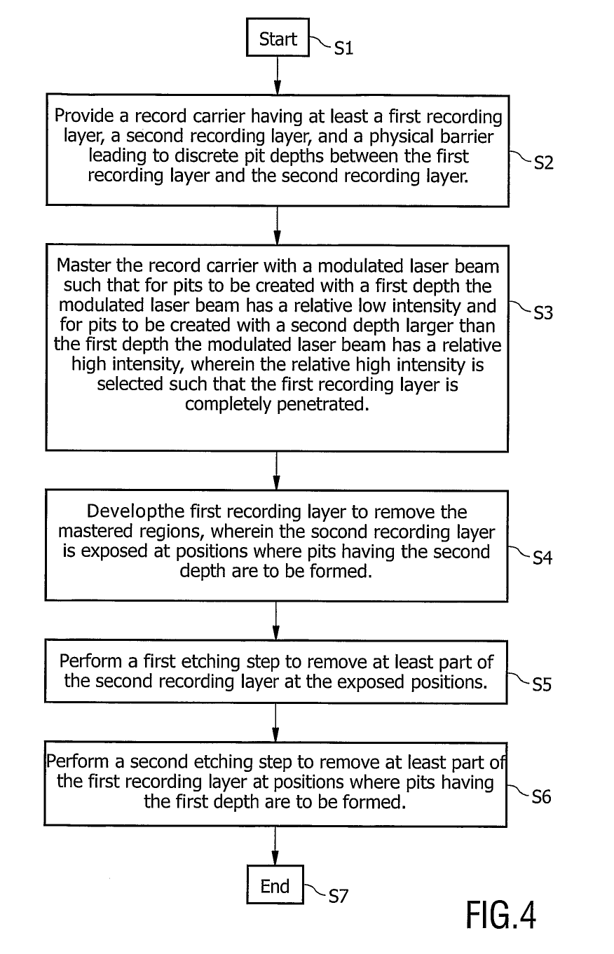

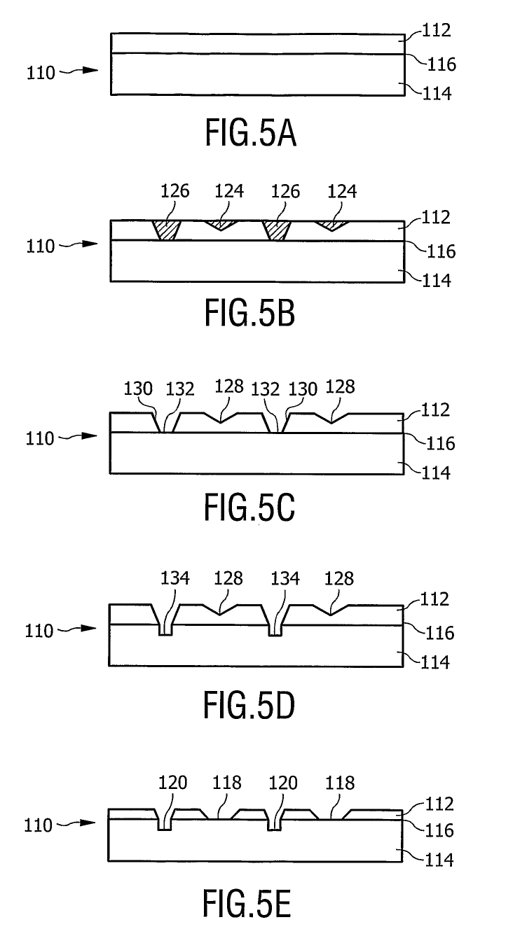

FIG. 4 is a flow chart illustrating a second embodiment of the method in accordance with the invention, while FIG. 5 illustrates a record carrier in accordance with the invention during processing with the method of FIG. 4.

The method depicted in FIG. 4 starts in step S1. In step S2 a record carrier having at least a first recording layer, a second recording layer and a physical barrier leading to discrete pit depths between said first recording layer and said second recording layer is provided. An example of such a record carrier 110 is shown in FIG. 5a. The physical barrier 116 of the record carrier 110 in this case is provided by intrinsic different recording materials of the first recording layer 112 and the second recording layer 114. In the present example the first recording layer 112 is a photoresist layer, which is spincoated on a glass substrate 114 forming the second recording layer.

In step S3 of the flow chart illustrated in FIG. 4 the record carrier 110 is mastered with a modulated laser beam. The mastering is performed such that for pits to be created with a first depth 118 (FIG. 5e) the modulated laser beam has a relative low intensity. For pits to be created with a second depth 120 (FIG. 5e) larger than said first depth 118 the modulated laser beam has a relative high intensity. The relative high intensity is selected such that the first recording layer 112 is completely penetrated as indicated by the areas 126 of FIG. 5b. The relative low intensity of the modulated laser beam penetrates only about the half of the first recording layer 112, as indicated by the areas 124 in FIG. 5b.

In step S4 of FIG. 4 the first recording layer 112 is developed to remove the mastered regions 124, 126. Thereby the second recording layer 114 is exposed at positions 132 where pits having a second depth 120 are to be formed. The result of the developing step is shown in FIG. 5c. Deep V-shaped grooves/pits 130 expose positions 132 of the second recording layer 114 at positions where pits having the second depth 120 (FIG. 5e) are to be formed. V-shaped grooves/pits 128 having a lesser depth are formed at positions where pits having the first depth 118 (FIG. 5e) are to be formed.

In step S5 of FIG. 4 a first etching step is performed to remove at least a part of the second recording layer 114 at the exposed positions 132. A suitable etching agent for the first etching step is for example CF₄. The result of the first etching step is shown in FIG. 5d, wherein the removed portions of the second recording layer 114 are indicated at 134. It is to be noted that the etching agent used in the first etching step is selected such that only material of the second recording layer 114 is removed, while the first recording layer 112 remains essentially unchanged.

In step S6 of FIG. 4 a second etching step is performed to remove at least part of said first recording layer 112 at positions where pits having the first depth 118 (FIG. 5e) are to be formed. A suitable etching agent for the second etching step is for example O₂. The etching agent used in the second etching step is selected such that only material of the first recording layer 112 is removed, while the second recording layer 114 remains essentially unchanged. In the depicted example the first recording layer 112 is not only removed at positions where pits having the first depth 118 (FIG. 5e) are to be formed, but about the half of the first recording layer 112 is uniformly removed such that the surface of the second recording layer 114 is exposed at positions where pits having the first depth 118 are created, as indicated in FIG. 5e. This FIG. 5e shows the record carrier 110 at the end (step S7 of FIG. 4) of the second embodiment of the method in accordance with the invention. It is clear to the person skilled in the art that the first and second depths 118, 120 of the pits may be defined by suitably controlling the reactive iron etching processes.

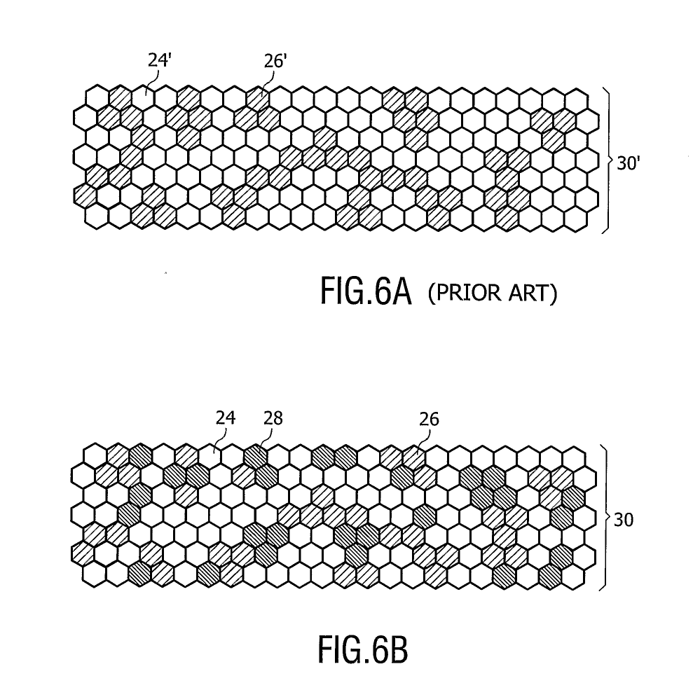

FIG. 6a shows an example of a two-dimensional data pattern 30′ in accordance with the prior art. This data pattern comprises a honeycomb structure, wherein pits 26′ have a different reflection level than the matrix level 24′.

A two-dimensional data pattern 30 that may be created in accordance with the present invention is illustrated in FIG. 6b. The black pits 28 are deeper than the grey pits 26 which in turn are deeper than the matrix level 24. Thereby the data pattern comprises two reflection levels different from the matrix level.

Finally, it is to be noted that equivalents and modifications not described above may also be employed without departing from the scope of the invention, which is defined in the accompanying claims.

1. A record carrier (10; 110) for creating a multi-level ROM optical medium, said record carrier comprising a first recording layer (12; 112) and at least a second recording layer (14; 114), characterized in that between said first recording layer (12; 112) and said second recording layer (14; 114) there is provided a physical barrier (16; 116) leading to discrete pit depths (18, 20; 118, 120).

2. The record carrier (10) in accordance with claim 1, characterized in that said physical barrier (16) comprises an interface layer (22) that breaks down by a predetermined breakdown mechanism, particularly by a photochemical reaction or a thermal effect.

3. The record carrier (10) in accordance with claim 2, characterized in that said interface layer (22) is bleachable by a certain amount of photons, wherein the bleached material is solvable in a developer used in said photochemical reaction.

4. The record carrier (10) in accordance with claim 2, characterized in that said interface layer (22) is an inhibition layer, which becomes sensitive above a predetermined laser power of a laser used for mastering.

5. The record carrier (10) in accordance with claim 2, characterized in that said interface layer (22) is made from a material selected from the following group: PMMA, silicon nitride, aluminum nitride.

6. The record carrier (110) in accordance with claim 1, characterized in that said physical barrier (116) is formed in that said first recording layer (112) and said second recording layer (114) are made from intrinsic different materials.

7. The record carrier (110) in accordance with claim 6, characterized in that said first recording layer (112) and said second recording layer (114) comprise different photosensitive compounds.

8. The record carrier (110) in accordance with claim 6, characterized in that said first recording layer (112) and said second recording layer (114) comprise different compositions.

9. The record carrier (110) in accordance with claim 6, characterized in that said first recording layer (112) and said second recording layer (114) comprise different sensitivities with respect to laser light (UV) illumination.

10. The record carrier (110) in accordance with claim 6, characterized in that said first recording layer (112) and said second recording layer (114) comprise different sensitivities with respect to a photochemical development.

11. The record carrier (110) in accordance with claim 6, characterized in that said first recording layer (112) and said second recording layer (114) comprise different sensitivities with respect to different etching agents.

12. The record carrier (10; 110) in accordance with claim 1, characterized in that it is adapted for two-dimensional data recording.

13. The record carrier (10; 110) in accordance with claim 12, characterized in that it comprises a two-dimensional data pattern with at least two reflection levels different from a matrix level.

14. A method for writing a record carrier to create a multi-level ROM optical medium, said record carrier (10) comprising a first recording layer (12) and at least a second recording layer (14), characterized by the following steps:
providing a record carrier having a physical barrier (16) leading to discrete pit depths (18, 20) between said first recording layer (12) and said second recording layer (14); and
writing, with a modulated laser beam, a plurality of pits on said record carrier, wherein:
for writing pits having a first depth (18), the power of said modulated laser beam is selected such that said first recording layer (12) is penetrated without breaking down said physical barrier (16); and
for writing pits having a second depth (20) larger than said first depth (18), the power of said modulated laser beam is selected such that said first recording layer (12) is penetrated, said physical barrier (16) is broken down, and said second recording layer (14) is penetrated.

15. The method in accordance with claim 14, characterized in that said physical barrier (16) comprises an interface layer (22).

16. A method for writing a record carrier (110) to create a multi-level ROM optical medium, said record carrier (110) comprising a first recording layer (112) and at least a second recording layer (114), characterized by the following steps:
providing a record carrier (110) having a physical barrier (116) leading to discrete pit depths (118, 120) between said first recording layer (112) and said second recording layer (114); and
mastering said record carrier (110) with a modulated laser beam such that for pits to be created with a first depth (118) said modulated laser beam has a relative low intensity and for pits to be created with a second depth larger (120) than said first depth (118) said modulated laser beam has a relative high intensity, wherein said relative high intensity is selected such that said first recording layer (112) is completely penetrated;
developing said first recording layer (112) to remove the mastered regions, wherein said second recording layer (114) is exposed at positions (124) where pits having the second depth (120) are to be formed;
performing a first etching step to remove at least a part of said second recording layer (114) at said exposed positions (124); and
performing a second etching step to remove at least part of said first recording layer (112) at positions where pits having said first depth (118) are to be formed.

17. The method in accordance with claim 16, characterized in that said first recording layer (112) is a photoresist and in that said second recording layer (114) is a glass substrate.
